(19) United States
(12) Patent Application Publication
(10) Pub. No.: US 2025/0153594 A1
(43) Pub. Date: May 15, 2025

(54) SYSTEMS AND METHODS FOR MANAGING ENERGY RESOURCES FOR MULTIPLE VEHICLES

(71) Applicant: Paired Power, Inc., Campbell, CA (US)

(72) Inventors: David Thompson McCalmont, Palo Alto, CA (US); Maxym Makhota, Campbell, CA (US); Aaron William McCalmont, Santa Clara, CA (US)

(21) Appl. No.: 18/612,097

(22) Filed: Mar. 21, 2024

Related U.S. Application Data
(63) Continuation-in-part of application No. 18/506,397, filed on Nov. 10, 2023.

(51) Int. Cl. B60L 53/63; B60L 53/51; B60L 53/53; B60L 53/62; B60L 53/65; B60L 53/67; G06Q 50/06; H02J 3/00; H02J 3/32; H02J 3/38

(52) U.S. Cl. CPC B60L 53/63; B60L 53/51; B60L 53/53; B60L 53/62; B60L 53/65; B60L 53/67; G06Q 50/06; H02J 3/003; H02J 3/004; H02J 3/32; H02J 3/38; H02J 2300/24

(57) ABSTRACT

Example systems and methods for managing energy resources for multiple vehicles are described. In one implementation, a control system determines an amount of energy presently available from an existing power grid connection and an amount of energy presently received from a solar array. The control system further identifies a present state-of-charge level of a stationary battery. The control system also allocates energy to charge a first plurality of electric vehicles, where the energy is allocated from at least one of the existing power grid connections, the solar array, or the stationary battery based on the amount of energy presently available from or being consumed by the existing power grid connection, the amount of energy presently received from the solar array, and the present state-of-charge level of the stationary battery.

### CROSS REFERENCE TO RELATED APPLICATIONS

This application is a Continuation in Part of U.S. application Ser. No. 18/506,397, entitled “Energy Management Systems and Methods,” filed Nov. 10, 2023, the disclosure of which is incorporated herein by reference in its entirety.

### TECHNICAL FIELD

The present disclosure relates to systems and methods for managing energy, such as energy used to charge batteries, electric vehicles, and other devices.

### BACKGROUND

The growing use of electric vehicles requires an increased number of charging locations capable of recharging batteries contained in electric vehicles. In many existing systems, electric vehicle charging stations are provided to charge the batteries of one or more electric vehicles. These existing systems typically receive power from the power grid to charge the electric vehicle batteries.

However, in many situations, existing power grids do not have adequate grid capacity to service a large number of electric vehicles. For example, an existing power grid's capacity may be limited such that it cannot charge a fleet of electric vehicles. In many situations, it is not possible to expand the existing power grid's capacity. If power grid expansion is possible, it may be difficult, expensive, and time-consuming to implement.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of an electric vehicle charging system.

FIG. 2 depicts a top perspective view of an embodiment of an electric vehicle charging station.

FIG. 3 is a block diagram depicting an embodiment of an energy controller.

FIG. 4 illustrates an example method for managing energy received from one or more solar cells.

FIG. 5 illustrates an example method for directing energy to a stationary battery and/or an electric vehicle.

FIG. 6 illustrates an example method for directing energy to an electric vehicle and/or a stationary battery based on at least one future activity.

FIG. 7 illustrates an example approach to allocating energy between an electric vehicle and a stationary battery.

FIG. 8 is a block diagram depicting another embodiment of an electric vehicle charging system.

FIG. 9 is a block diagram depicting an embodiment of a control system.

FIG. 10 depicts a front view of an embodiment of an electric vehicle charging station capable of charging multiple electric vehicles simultaneously.

FIG. 11 illustrates an example implementation of a control system receiving multiple types of data from any number of data sources, data services, and the like.

FIG. 12 illustrates an example method for managing energy resources for multiple electric vehicles.

FIG. 13 is a block diagram depicting an embodiment of an artificial intelligence engine.

FIG. 14 depicts a block diagram of an embodiment of a computing device.

### DETAILED DESCRIPTION

The energy management systems and methods described herein provide an electric vehicle charging system that can charge batteries in electric vehicles and other devices. The described electric vehicle charging system uses solar cells to generate energy that can charge any type of battery, such as a stationary battery or an electric vehicle battery. An energy controller manages the charging of two or more batteries to optimize charging of each battery based on various priorities and modes of operation.

In the following description, reference is made to the accompanying drawings that form a part thereof, and in which are shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, system, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a solid-state drive, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flow diagram and/or block diagram block or blocks.

The systems and methods described herein support the charging of one or more electric vehicles or other devices. In some embodiments, the systems and methods can charge multiple electric vehicles or devices simultaneously using one or more arrays of solar cells, photovoltaic modules, and the like. As used herein, “solar cells” refers to any photovoltaic module or other mechanism that converts solar energy into an electrical signal.

Embodiments of the systems and methods described herein support the charging of one or more electric vehicles or other devices using solar cells. The use of solar cells allows charging locations to be created without the need for a connection to a traditional power grid. This simplifies creation of the charging locations and avoids problems caused by fully utilized electrical panels, service connections, and other electrical circuits. For example, the interconnection of charging stations to the utility grid can be complex and costly. Some charging stations use a significant amount of power, which may not be readily available through the electric service capacity of existing buildings located near a particular charging station. The described systems and methods eliminate the time and expense required to create buried or overhead connections for power lines connected to the power grid.

Charging locations, as discussed herein, can be located anywhere, but are particularly useful in areas where drivers park their electric vehicles for a period of time, such as a corporate campus, shopping center, retail store, school, convention center, sports arena, apartment building, park, beach, residential location, and the like. As adoption of electric vehicles grows and becomes more prevalent, the demand for charging locations that provide a charge over an extended period of time, such as workplace charging, will increase. In these types of locations, drivers of electric vehicles can enjoy the convenience of charging their vehicle while working, shopping, attending school, or performing other activities. Providing these charging locations is beneficial to, for example, business owners and employers who want to provide charging stations for drivers and/or employees without incurring costly installations requiring access to the power grid. Additionally, as demand grows for EV (electric vehicle) charging in locations that are distant from the electric power grid (or that lack adequate power from the power grid), the described systems and methods will become more desirable.

As more electric vehicles are produced and driven, it is important to provide more electric vehicle charging stations that are convenient for owners and drivers of electric vehicles. Providing various types of charging stations in multiple distributed locations will support the growing number of electric vehicles used on a regular basis.

As discussed herein, off-grid systems (not connected to the electric utility grid) may be desirable in a variety of situations. Typically, off-grid systems are smaller than the utility grid and often have limitations related to their ability to generate energy and store energy. In these off-grid systems, the energy management system is important to the proper operation of the system. For example, if the energy generator is presently producing power at a level that is sufficient to meet the needs of the connected loads, then the storage system may not be utilized (e.g., it would not be charging or discharging). If the energy generator is producing more power than is required by the connected loads, the excess energy from the energy generator could be used to charge the storage system. Conversely, if the energy generator is producing less power than is required by the connected loads, the storage system can be discharged to augment the power coming from the energy generator to provide sufficient power to the connected loads to keep them operating at their correct voltages and currents.

Accordingly, it is important to carefully manage energy flows when both energy generation and storage are limited. In some embodiments, the energy management objective of an off-grid system is to provide power to the connected load for as long as possible under different environmental conditions. For example, if the energy generator is a solar or wind power generator, which is intermittent and not available at certain times of the day, the storage system should be carefully managed to keep providing power to the connected load for as long as possible during periods when the generator is offline. The algorithms and procedures that provide this careful and varying control of the power flows in an off-grid system are important to keep connected loads online and to provide a positive user experience. The systems and methods described herein are related to the algorithms and procedures that provide this control of the power flows in an off-grid or microgrid system.

In some embodiments, the systems and methods described herein may avoid full battery discharge and may preempt possible inverter faults and shutdown scenarios. The described systems and methods are also able to maximize available power to one or more electric vehicles or other devices while minimizing wasted power. Additionally, the systems and methods described herein can provide an improved user experience by maximizing available power to charge the user's electric vehicle or other device. The described systems and methods further use best practices to keep batteries in good health. In some embodiments, the systems and methods described herein may monitor charging and solar energy production statistics for each location.

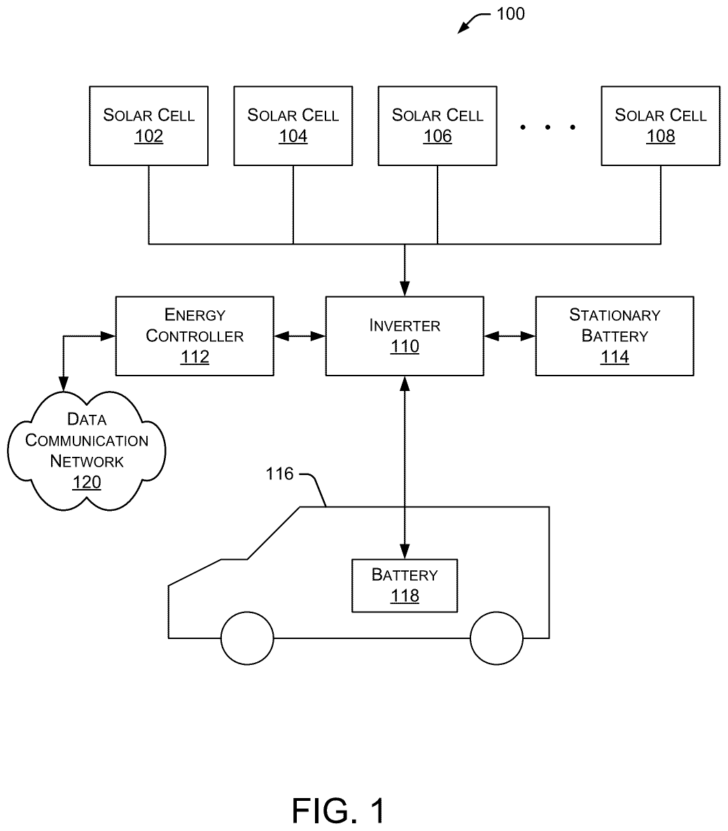

FIG. 1 is a block diagram depicting an embodiment of an electric vehicle charging system 100. Multiple solar cells 102, 104, 106 and 108 are electrically coupled to an inverter 110 which may be configured to manage power signals received from the plurality of solar cells. Solar cells 102-108 generate power signals (e.g., energy) to inverter 110 based on sunlight received by solar cells 102-108. These power signals may include a voltage and/or a current. Inverter 110 is electrically coupled to one or more electric vehicles 116, each of which includes one or more batteries 118.

An energy controller 112 is coupled to inverter 110 and may perform a variety of functions, such as managing or consolidating power signals received from solar cells 102-108. For example, energy controller 112 may manage the consolidation of one or more of the power signals from solar cells 102-108 into an output signal that is provided from inverter 110 to battery 118 in electric vehicle 116. Additionally, energy controller 112 can manage the consolidation of one or more of the power signals from solar cells 102-108 and store that energy in a stationary battery 114. As shown in FIG. 1, stationary battery 114 is separate from battery 118 in electric vehicle 116. In some embodiments, stationary battery 114 stores energy from any number of solar cells 102-108 and may provide at least a portion of the stored energy to electric vehicle 116 to charge battery 118 in electric vehicle 116. In some embodiments, stationary battery 114 is part of electric vehicle charging system 100 and may be physically attached to the structure of electric vehicle charging system 100, such as the structure that supports solar cells 102-108 and/or other devices shown in FIG. 1.

In some embodiments, inverter 110 can adjust the voltage level of an output signal provided to electric vehicle 116 for charging battery 118. Energy controller 112 maintains the output voltage level within an acceptable range for the vehicle being charged. In some embodiments, inverter 110 can adjust the present level of the output signal provided to electric vehicle 116. For example, inverter 110 can maintain the output electrical current level within an acceptable range for the vehicle being charged. As used herein, the “output signal” may contain a voltage and/or a current.

In some embodiments, inverter 110 includes a passive switching matrix or an active device, such as a DC-to-DC converter or a computer-managed power boost or buck system.

Using inverter 110, the electric vehicle charging system 100 can receive DC power from one or more solar cells, convert the power to AC (with the inverter), and deliver the AC power to the electric vehicle's charge port. Electric vehicle 116 may be any type of car, truck, bus, motorcycle, scooter, bicycle, and the like. Battery 118 stores a charge within electric vehicle 116 to power that electric vehicle.

As discussed herein, energy controller 112 may manage or consolidate power signals received from solar cells 102-108. For example, energy controller 112 may direct power signals to stationary battery 114, battery 118 in electric vehicle 116, or any other device or system. In some embodiments, energy controller 112 is coupled to communicate with a data communication network 120. For example, data communication network 120 may include any type of network, such as a local area network, a wide area network, the Internet, a cellular communication network, a Bluetooth, low energy or NFC wireless connection or any combination of two or more data communication networks.

Although not shown in FIG. 1, data communication network 120 may be coupled to any number of servers, devices, or other systems that perform a variety of operations. For example, data communication network 120 may be coupled to a server (not shown) that manages the operation of multiple energy controllers 112, electric vehicle charging operations, stationary battery charging operations, and the like. In some embodiments, data communication network 120 is coupled to weather monitoring services, weather forecasting services, services that monitor available vehicle charging stations in a particular area, electric vehicle tracking services, and the like.

In some embodiments, the system of FIG. 1 may be used, for example, to direct a vehicle to a specific charging station where the vehicle will receive the best performance, such as the best charge. Data communication network 120 supports communication with other systems and methods that can provide the condition of multiple vehicle charging stations, identify the vehicle charging stations with the fullest stationary batteries, determine which vehicle charging stations are in the best environmental locations (e.g., vehicle charging stations that are the least shaded or in the most direct sunlight at that point in time).

Although FIG. 1 illustrates the use of solar cells 102-108, alternate embodiments may use any type of renewable energy source. For example, alternate embodiments may include wind generators, turbines, hydroelectric generators, geothermal energy generators, tidal energy generators, wave energy generators, and the like.

Stationary battery 114 may use any type of energy storage system. For example, stationary battery 114 may be a lithium-ion battery, a lithium-ferrous-phosphate battery, a lead-acid battery, a zinc-air battery, a sulphur battery, a flow battery, a nickel-cadmium battery, or any other type of battery.

Additionally, battery 114 may use alternate types of storage mechanisms. For example, battery 114 may use a flywheel mechanism to store energy. Energy is used to spin the flywheel, then energy is harvested from the flywheel when needed to charge battery 118 in electric vehicle 116. When extra energy is received, it may be used to speed up the flywheel. When energy is harvested from the flywheel, its rotation will slow down.

In other embodiments, battery 114 may use any type of energy storage system that allows extra energy to be stored in the system and allows energy to be retrieved from the system.

In some embodiments, the electric vehicle charging system shown in FIG. 1 is an off-grid system. For example, electric vehicle charging system 100 may not be connected to the power grid or other power source. Instead, electric vehicle charging system 100 generates its own energy from solar cells 102-108 and uses that energy to charge stationary battery 114, vehicle battery 118, and other devices or systems. Since the electric vehicle charging system is off-grid, it can be conveniently located in any location that is exposed to sunshine regardless of the availability of power from the power grid or other power source.

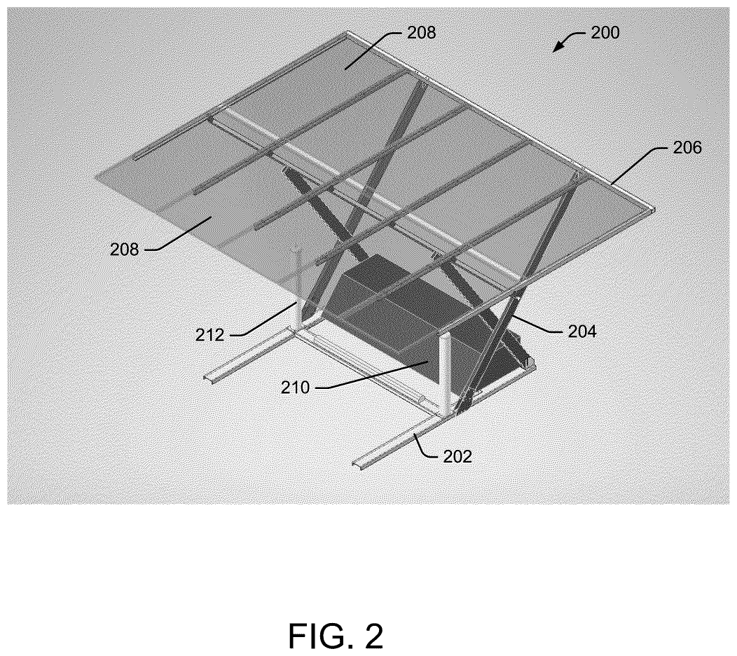

FIG. 2 depicts a top perspective view of an embodiment of an electric vehicle charging station 200. As shown in FIG. 2, electric vehicle charging station 200 includes a foundation 202 that may contain multiple components that support the remainder of electric vehicle charging station 200. In some embodiments, foundation 202 may include a ballast or other heavy material to help secure electric vehicle charging station 200 in a particular location. In some implementations, a battery may be used as a ballast that rests upon, or is secured to, other support pieces of foundation 202. In other embodiments, foundation 202 may be secured to the surface using, for example, ground screws.

Support mechanisms 204 are attached to foundation 202. Any type of support mechanism can be used to support a table 206, which provides a structure to support multiple solar panels 208. In the example of FIG. 2, table 206 can support ten solar panels 208. Other embodiments may support any number of solar panels 208 in any configuration. In some embodiments, solar panels 208 generate power based on light received on a top surface (e.g., the surface opposite foundation 202) of each solar panel 110. In other embodiments, solar panels 208 may generate power based on light received on a top surface and a bottom surface of each solar panel 208. These types of solar panels may be referred to as bifacial solar panels.

The power generated by solar panels 208 may be used to charge an electric vehicle, charge an electric device, charge a battery, operate a device, and the like. As shown in FIG. 2, electric vehicle charging station 200 may include one or more stationary batteries 210. In some embodiments, stationary batteries 210 may store power generated by solar panels 208. The power stored in stationary batteries 210 may be used to charge an electric vehicle, charge an electric device, charge a battery, operate a device, and the like. As shown in FIG. 2, stationary batteries 210 may be physically attached to the structure of vehicle charging station 200. Although not shown in FIG. 2, other components, such as energy controller 112 and inverter 110 may also be physically attached to the structure of vehicle charging station 200.

In some embodiments, electric vehicle charging station 200 is designed for a vehicle to park under table 206. In this situation, electric vehicle charging station 200 provides shade for the vehicle while generating power simultaneously. As discussed above, the power generated by solar panels 208 may charge the vehicle, stationary batteries 210, or any other device. Electric vehicle charging station 200 may further include one or more bumpers or bollards 212 that prevent a vehicle from accidentally driving into support mechanism 204, stationary batteries 210, or any other part of electric vehicle charging station 200.

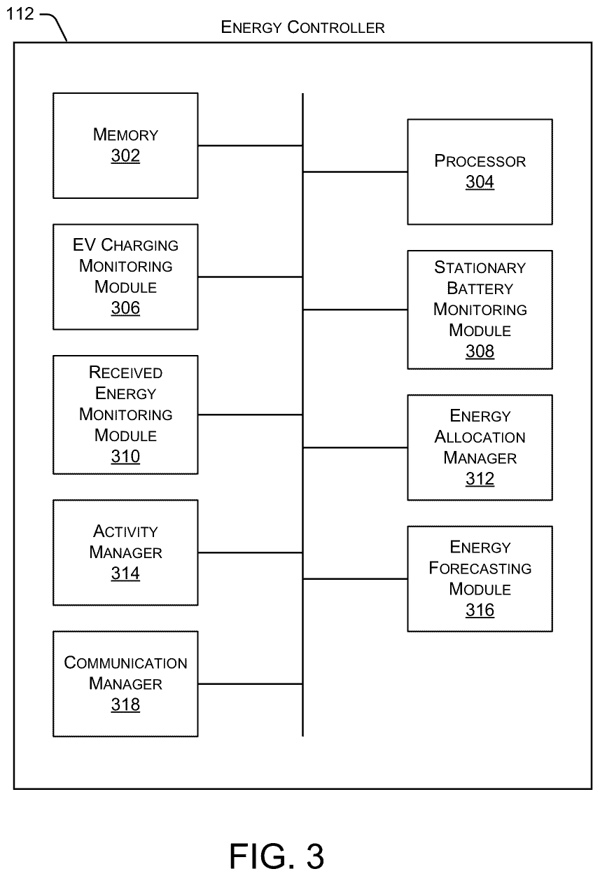

FIG. 3 is a block diagram depicting an embodiment of an energy controller 112. In this example, energy controller 112 includes a memory 302 and a processor 304. Processor 304 performs various functions necessary to perform the methods and operations discussed herein with respect to charging electric vehicles. Memory 302 stores various data used by processor 304 as well as other components and modules in energy controller 112.

In this example, energy controller 112 includes an EV (electric vehicle) charging monitoring module 306, which is capable of monitoring the power received from solar cells 102-108, a power grid, or a battery. EV charging monitoring module 306 operates to monitor one or more electric vehicles 116 connected to energy controller 112. For example, EV charging monitoring module 306 may monitor a vehicle type, a type of charger required (such as Level 2 or Level 3), and an active charging status (such as state-of-charge (SoC) percentage) of the vehicle's battery 118.

In some embodiments, a stationary battery monitoring module 308 is capable of monitoring one or more stationary batteries 114. For example, stationary battery monitoring module 308 may monitor a battery charging status (such SoC percentage) of at least one stationary battery 114.

Energy controller 112 may also include a received energy monitoring module 310 that monitors energy received from solar cells 102-108. The amount of energy presently received from solar cells 102-108 may be used to determine where to direct the received energy (e.g., to stationary battery 114 and/or battery 118 in electric vehicle 116), as discussed herein. For example, an energy allocation manager 312 may determine how to allocate received energy between stationary battery 114, battery 118 in electric vehicle 116, or other devices. This allocation may be based on various factors (discussed herein), such as current received energy from the generator, forecast sunlight, state-of-charge of the stationary battery, state-of-charge of the vehicle battery, expected vehicle charging needs, and the like.

Energy controller 112 may also include an activity manager 314 that monitors and manages various activities that may impact charging of battery 118 in electric vehicle 116 and/or stationary battery 114. As discussed herein, various upcoming activities or events may affect priorities between charging battery 118 in electric vehicle 116 or stationary battery 114. An energy forecasting module 316 monitors various forecasts (e.g., weather or sunshine forecasts, remaining hours of daylight, forecast charging level to be required by a yet-to-arrive EV, etc.) that may impact available energy for charging battery 118 in electric vehicle 116 and/or stationary battery 114.

In some embodiments, a communication manager 318 allows energy controller 112 to communicate with other systems or devices via any communication medium and using any communication protocol.

In some embodiments, an electric vehicle might request a particular charging level and the system may deliver at that level based on available capacity of the stationary battery and the available sunlight. In another embodiment, the described systems and methods may anticipate future charging needs for future electric vehicles based on the historical pattern of how the charging system has been used. Based on the anticipated future charging needs for future electric vehicles, the systems and methods may decide how to limit the current charging session for a particular electric vehicle. In another example, the described systems and methods may constrain charging of a particular electric vehicle based on a partially depleted battery and/or limited available sunlight.

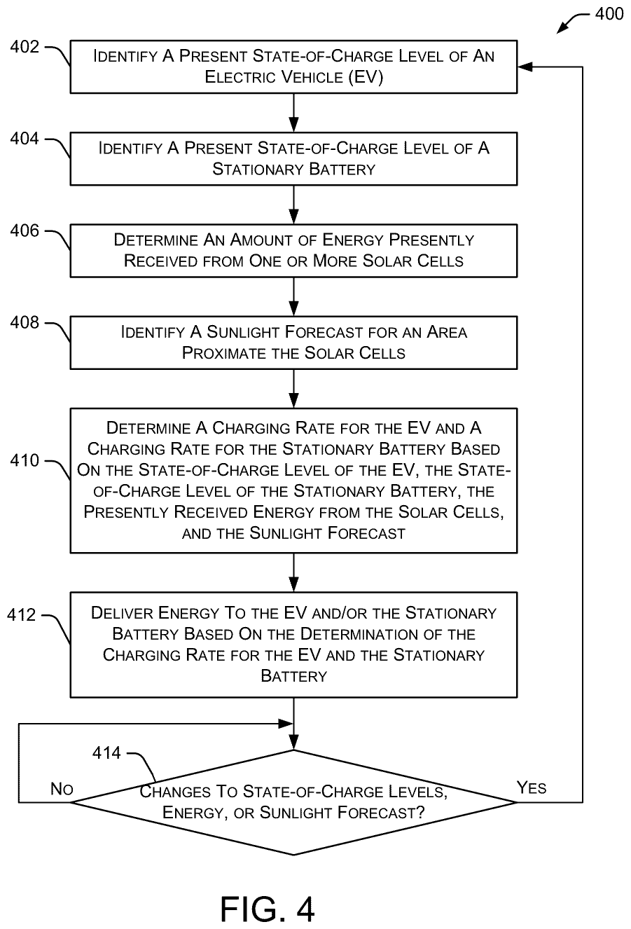

FIG. 4 illustrates an example method 400 for managing energy received from one or more solar cells. Initially, method 400 identifies 402 a present state-of-charge level of an electric vehicle. For example, method 400 may identify a current state-of-charge level of battery 118 in electric vehicle 116 shown in FIG. 1. The method continues by identifying 404 a present state-of-charge level of a stationary battery. For example, method 400 may identify a present state-of-charge level of stationary battery 114 shown in FIG. 1.

Method 400 also determines 406 an amount of energy presently received from one or more solar cells. For example, method 400 may determine an amount of energy presently received from one or more of solar cells 102-108 shown in FIG. 1. Method 400 continues by identifying 408 a sunlight forecast for an area proximate the solar cells. For example, method 400 may identify a sunlight forecast for an area proximate solar cells 102-108 shown in FIG. 1. The sunlight forecast may be for the next few minutes, hours, days, and the like. In some embodiments, the systems and methods described herein may also identify other environmental conditions, such as temperature and wind. The air temperature or wind speed may impact the performance of the stationary battery 114 and/or solar cells 102-108. The described systems and methods may further determine remaining daylight at a particular location, charging needs of future vehicles that have not yet arrived, and the like.

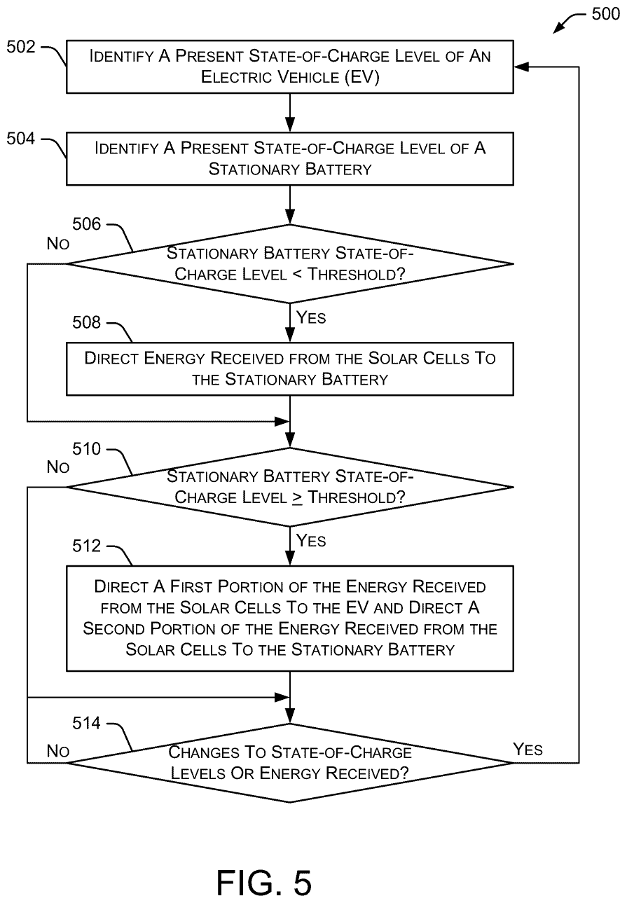

Method 400 further determines 410 a charging rate for the electric vehicle and a charging rate for the stationary battery based on: the state-of-charge level of the electric vehicle, the requested charge rate of the EV, the state-of-charge level of the stationary battery, the presently received energy from the solar cells, and the sunlight forecast. Details regarding the determination 410 are discussed herein, for example with respect to FIGS. 5-7. In some embodiments, both the charging rate and the state-of-charge level for both the electric vehicle and the stationary battery are important. For example, if an electric vehicle is 80% charged when it plugs into a charging station but also requests the maximum charge rate, that could significantly reduce the available energy to charge other electric vehicles that come to the charging station at a later time. In that situation, the systems and methods described herein may choose to limit the charge rate for the electric vehicle based on the high initial state-of-charge level of the presently charging vehicle. Since the electric vehicle is already charged to 80%, it doesn't need to be charged further at a fast rate.

Method 400 continues by delivering 412 energy to the electric vehicle and/or the stationary battery based on the determination 410 of the charging rate for the electric vehicle and the stationary battery. For example, method 400 may deliver energy to electric vehicle 116 and/or stationary battery 114 shown in FIG. 1.

Method 400 continues by monitoring 414 changes to state-of-charge levels (e.g., electric vehicle state-of-charge level and stationary battery state-of-charge level), energy received from the one or more solar cells, or the sunlight forecast. If the monitoring 414 detects changes to any of those factors, the method returns to 402 to identify a present state-of-charge level of the electric vehicle. If there are no changes to the factors, method 400 continues monitoring 414 for changes.

FIG. 5 illustrates an example method 500 for directing energy to a stationary battery and/or an electric vehicle. Initially, method 500 identifies 502 a present state-of-charge level of an electric vehicle and identifies 504 a present state-of-charge level of a stationary battery. Method 500 then determines 506 whether the stationary battery state-of-charge level is less than a threshold value. As discussed in greater detail herein, the threshold value determines how energy received from the solar cells is allocated to the stationary battery and/or the electric vehicle. If 506 determines that the stationary battery state-of-charge level is less than the threshold value, then all energy received from the solar cells is directed 508 to the stationary battery. If 506 determines that the stationary battery state-of-charge level is not less than the threshold value, then method 500 continues to 510.

Method 500 continues by determining 510 whether the stationary battery state-of-charge level exceeds (or is equal to) the threshold value. If 510 determines that the stationary battery state-of-charge level is greater than or equal to the threshold value, then 512 directs a first portion of the energy received from the solar cells to the electric vehicle and directs a second portion of the energy received from the solar cells to the stationary battery. If 510 determines that the stationary battery state-of-charge level is less than the threshold value, then method 500 continues to 514.

Method 500 continues by monitoring 514 changes to state-of-charge levels (e.g., electric vehicle state-of-charge level and stationary battery state-of-charge level) or energy received from the one or more solar cells. If the monitoring 514 detects changes to any of those factors, the method returns to 502 to identify a present state-of-charge level of the electric vehicle. If there are no changes to the factors, method 500 continues monitoring 514 for changes.

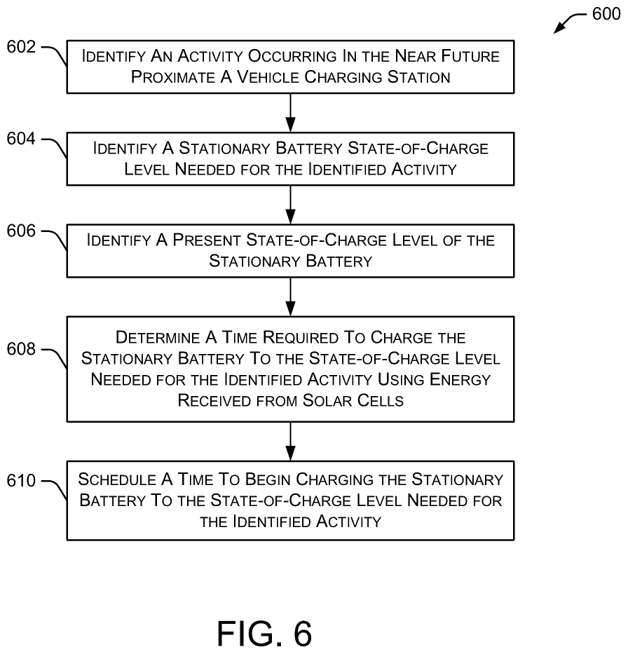

FIG. 6 illustrates an example method 600 for directing energy to an electric vehicle and/or a stationary battery based on at least one future activity. Initially, method 600 identifies 602 an activity occurring in the near future proximate a vehicle charging location. For example, an activity occurring in the near future may happen within a few minutes, a few hours, a few days, or any other time period. In some embodiments, the activity may involve increased use of a vehicle charging location during a particular period of time. A vehicle charging location may include any type of area that supports the charging of one or more electric vehicles, such as the embodiments shown in FIGS. 1 and 2.

Method 600 continues by identifying 604 a stationary battery state-of-charge level needed for the identified activity. For example, if the identified activity is likely to require the charging of an increased number of electric vehicles, the stationary battery may need a full charge to support as many electric vehicles as possible. The method further identifies 606 identifies a present state-of-charge level of the stationary battery. Method 600 then determines 608 a time required to charge the stationary battery to a state-of-charge level needed for the identified activity using energy received from one or more solar cells. The time required to charge the stationary battery to the necessary state-of-charge level may also be based on the current amount of sunshine and the forecast sunshine in the near future. Based on these determinations, method 600 may schedule 610 a time to begin charging the stationary battery to the state-of-charge level needed for the identified activity.

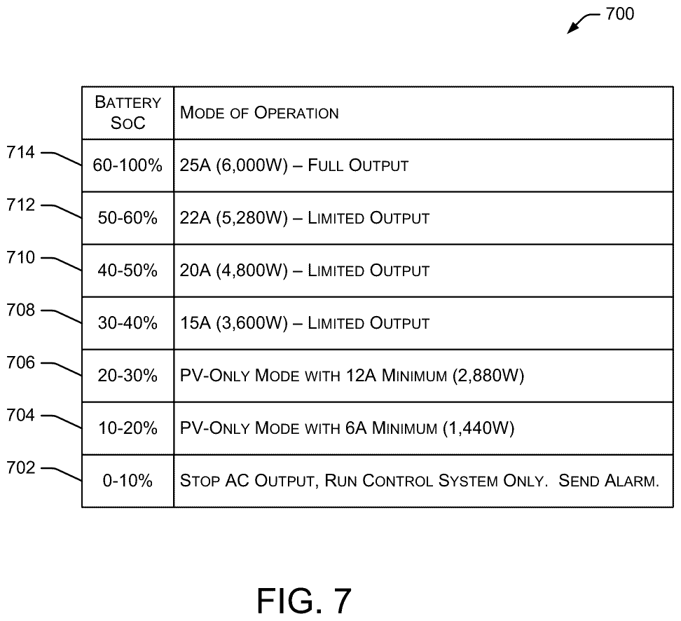

FIG. 7 illustrates an example approach 700 to allocating energy between an electric vehicle and a stationary battery. In some embodiments, approach 700 determines a power level to be delivered to electric vehicle 116 based on both the available capacity in stationary battery 114 at that moment in time as well as any other solar power that is available, such as solar power provided by one or more of solar cells 102-108. At a particular threshold, approach 700 determines that there is insufficient energy left in stationary battery 114 to assure its ongoing operation. In some embodiments, this threshold is set at 20% of energy left in stationary battery 114, also referred to as 20% SoC (State-of-Charge). If the energy left in stationary battery 114 drops below 20%, energy controller 112 changes the operation of electric vehicle charging system 100 (shown in FIG. 1) to “PV Only Mode”, which means all energy going to electric vehicle 116 comes from solar cells 102-108 and no energy is provided to electric vehicle 116 from stationary battery 114. This PV Only Mode preserves the remaining charge in stationary battery 114 to ensure that power is available to operate the components in electric vehicle charging system 100, such as inverter 110 and energy controller 112.

In some embodiments, at a lower threshold (e.g., 10% energy left in stationary battery 114), the charging energy previously provided to electric vehicle 116 from solar cells 102-108 is redirected by energy controller 112 to charge stationary battery 114. If stationary battery 114 reaches the lower threshold, it indicates a situation where stationary battery 114 is at risk of exhausting all of its energy, which would prevent electric vehicle charging system 100 from operating. Thus, all energy from solar cells 102-108 is provided to stationary battery 114 to recharge it to a higher state-of-charge (e.g., at least the higher 20% threshold).

In the example of FIG. 7, multiple modes of operation are shown. For example, a first mode of operation 702 occurs when stationary battery 114 SoC is below 10%. As mentioned above, this mode stops AC output to electric vehicle 116 and provides all energy from solar cells 102-108 to stationary battery 114 to operate vehicle charging system 100. In some embodiments, first mode of operation 702 may generate an alarm and communicate the alarm to one or more users, administrators, systems, and the like. The alarm may identify the low SoC condition of stationary battery 114 and allow a user, administrator, or system to take additional steps to prevent depletion of stationary battery 114.

As shown in FIG. 7, a second mode of operation 704 occurs when stationary battery 114 SoC is above 10% but below 20%. Mode 704 causes energy controller 112 to direct energy from solar cells 102-108 to electric vehicle 116, but doesn't allow any energy from stationary battery 114 to charge electric vehicle 116. Thus, mode 704 preserves the existing energy in stationary battery 114 to operate the electric vehicle charging system 100. In some embodiments, the energy provided from solar cells 102-108 to electric vehicle 116 is a minimum of 6 amps (6 A), which is 1,440 watts (1,440 W). In some embodiments, the 6 A minimum (or threshold) is based on the SAE (Society of Automotive Engineers) J1772 Standard for Level 2 EV chargers, which requires a minimum current of 6 A to charge an EV. Thus, if the current is less than 6 A, the charger won't charge an EV. In some implementations, the 6 A limit is a minimum current needed to charge the EV, but current greater than 6 A may also be applied to the EV for charging.

In example approach 700, a third mode of operation 706 occurs when stationary battery 114 SoC is above 20% but below 30%. Mode of operation 706 causes energy controller 112 to direct up to 2,880 W of energy from solar cells 102-108 to electric vehicle 116, but doesn't allow any energy from stationary battery 114 to charge electric vehicle 116. In some embodiments, mode of operation 706 provides a minimum current of 12 A to charge the EV. If solar cells 102-108 generate more than 2,880 W of energy, the excess energy is used to recharge stationary battery 114. The amount of energy directed to electric vehicle 116 in mode of operation 706 may vary depending on what energy controller 112 (or a software algorithm associated with energy controller 112) determines is best at that moment. As discussed herein, energy controller can determine the best value to deliver to electric vehicle 116 and stationary battery 114 based on available sunlight, how much energy electric vehicle 116 is requesting, the SoC of stationary battery 114, anticipated future events (e.g., how many more electric vehicles are expected to show up that day to charge based on historical patterns), and the like.

As shown in FIG. 7, a fourth mode of operation 708 occurs when stationary battery 114 SoC is above 30% but below 40%. The 15 A current shown in mode of operation 708 is arbitrary and are determined by energy controller 112 or other system/algorithm. In some embodiments, the amount of energy provided to electric vehicle 116 may vary based on the amount of current requested by electric vehicle, the SoC of the electric vehicle battery 118, and other factors. For example, energy controller 112 may determine whether to split the energy from solar cells 102-108 between electric vehicle 116 and stationary battery 114 and in what ratio to split the energy. In other examples, energy controller 112 may combine all energy from solar cells 102-108 with energy from stationary battery 114 and provide all of the combined energy to electric vehicle 116.

As shown in FIG. 7, a fifth mode of operation 710 occurs when stationary battery 114 SoC is above 40% but below 50%. In mode of operation 710, the system may support 20 A of current to electric vehicle 116.

As shown in FIG. 7, a sixth mode of operation 712 occurs when stationary battery 114 SoC is above 50% but below 60%. In mode of operation 712, the system may support 22 A of current to electric vehicle 116.

As shown in FIG. 7, a seventh mode of operation 714 occurs when stationary battery 114 SoC is above 60%. In mode of operation 714, the system may support 25 A of current to electric vehicle 116.

The example of FIG. 7 represents a particular approach for allocating energy between an electric vehicle and a stationary battery. Other embodiments may use any number of operating modes based on any battery SoC settings and operating conditions.

In some embodiments, the multiple modes of operation 702-714 discussed above with respect to FIG. 7 may be dynamic and can change based on current situations, predicted situations, weather forecasts, anticipated demand for future charge sessions, and the like. For example, an electric vehicle charging system 100 (FIG. 1) may be located in an office parking lot that historically has not needed to charge many electric vehicle during the weekend. In that situation, the multiple modes of operation may include a PV-Only mode if stationary battery 114 SoC is less than 30% and a Stop AC Output mode if stationary battery 114 SoC is less than 10%. The multiple modes of operation may also include a third mode that provides all energy from solar cells 102-108 to an electric vehicle if stationary battery 114 SoC is above 30%. Thus, as long as stationary battery 114 is charged to at least 30%, all of the solar energy is used to charge an electric vehicle.

In some embodiments, the SoC of stationary battery 114 at a particular geographic location is monitored over time to identify patterns associated with stationary battery 114 usage, charging, and the like. Based on the monitored patterns of a particular stationary battery 114, the multiple modes of operation (and the SoC percentages associated with each mode of operation) may change to improve battery performance, electric vehicle charging, and other factors.

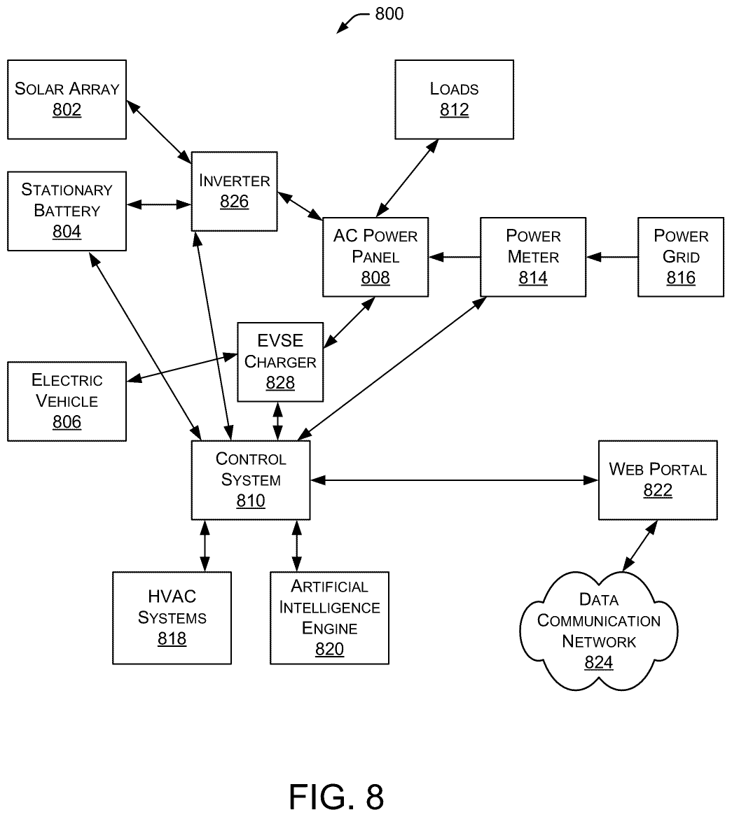

FIG. 8 is a block diagram depicting another embodiment of an electric vehicle charging system 800. As discussed herein, electric vehicle charging system 800 can manage the charging of multiple electric vehicles, such as a fleet of electric vehicles. In particular, electric vehicle charging system 800 can charge one or more batteries in electric vehicles and other devices. In some embodiments, electric vehicle charging system 800 may manage or distribute energy from one or more of a solar array 802, a stationary battery 804, an electric vehicle 806, or a power grid 816. As described herein, a control system 810 assists with the scheduling of electric vehicle charging based on available energy resources, anticipated future energy resources, anticipated energy resource pricing, anticipated electric vehicle charging needs, and the like.

The described systems and methods allow a fleet of electric vehicles to be charged using multiple energy sources (e.g., solar array 802, stationary battery 804, electric vehicle 806, or power grid 816) without requiring any changes to the existing power grid's capacity. In some situations, it is not possible (or not practical) to expand an existing power grid's capacity. In other situations, if power grid expansion is possible, it may be difficult, expensive, and time-consuming to implement. For example, the service connection between the power grid and the building receiving the power may be limited. In a particular fleet charging scenario, an existing service to a specific building may have limited expansion capacity and may not be sufficient to add multiple EV fleet vehicles. In this scenario, it ordinarily would be necessary to request a new service from the utility providing the power. That new service would need new wires run from a street transformer to a new meter and new main load center. This new service can take significant time for administrative activities, engineering activities, power studies, drawings, approvals, construction, and the like. In some situations, it may also require upgrading of the power distribution lines that serve the building, installing a new transformer, replacing an existing transformer, and the like. The time for all of these activities may be significant, such as several years or longer, and the costs will be significant.

In contrast, the systems and methods described herein support the charging of an increased number of electric vehicles and other devices using the existing power grid capacity. These systems and methods provide increased charging capabilities without the time and cost associated with expanding the capacity of an existing power grid connection. Additionally, as described herein, the systems and methods may reduce operating costs by reducing usage of grid power when utility demand charges are high. Operating costs may further be reduced by using as much solar power as possible, which may reduce the amount of grid power purchased.

In some embodiments, a fleet of electric vehicles may include any number of electric vehicles, such as buses, ambulances, emergency vehicles, service vehicles, and the like. A fleet of electric vehicles may be associated with a company, a city, a university, a school system, and the like. A particular fleet of electric vehicles may operate within a particular geographic area, such as an area associated with a school system, a service area associated with a company, a city's geographic area, and the like. Other types of electric vehicles that may utilize the systems and methods discussed herein include electric golf carts, electric drones, electric aircraft, electric delivery vehicles, and the like.

Different electric vehicles in a fleet may have different charging requirements (e.g., different charging amount depending on battery depletion, different charging intervals during the day, and the like). For example, an electric bus that is only driven for morning and afternoon school activities may be sufficiently charged once a day (e.g., at night) while another electric bus that is driven throughout the day may need to be charged more than once a day (e.g., once at mid-day and again at night). Further, the charging requirements for different electric vehicles in a fleet may vary from day-to-day depending on the number of miles driven on a particular day.

Depending on a particular electric vehicle's charging requirements, the systems and methods discussed herein may charge the electric vehicle using one or more energy sources based on various factors. For example, at night solar energy may not be available for charging, so the electric vehicle may be charged from power grid 816 or stationary battery 804. During the day, available energy from power grid 816 may be limited or expensive, so the electric vehicle may be charged using energy from solar array 802 or stationary battery 804. As discussed herein, control system 810 manages and schedules electric vehicle charging based on the needs of each individual electric vehicle and the availability of energy from solar array 802, stationary battery 804, power grid 816, and other electric vehicles 806 at different times of the day.

As shown in FIG. 8, control system 810 may also be coupled to one or more HVAC (heating, ventilation, and air conditioning) systems 818 that may be associated with various types of buildings or other structures. For example, control system 810 may reduce the amount of energy sent to solar array 802, stationary battery 804, or electric vehicle 806 when a HVAC system is activated. This is important to reduce the likelihood of demand charges because HVAC systems often require significant amounts of power when activated. In some embodiments, a similar approach of reducing energy sent to solar array 802, stationary battery 804, or electric vehicle 806 is implemented for other types of intermittent systems that require significant amounts of power, such as heavy machinery, pumps, motors, and the like. If those types of loads are activated at the same time as electric vehicle charging, the size and cost of utility demand charges will be increased considerably.

Control system 810 is further coupled to an artificial intelligence engine 820 that may assist with the management and scheduling of electric vehicle charging, as discussed herein. In some implementations, artificial intelligence engine 820 may be contained in control system 810.

Electric vehicle charging system 800 further includes an AC power panel 808 that distributes power throughout a building using, for example, wired circuits. One or more loads 812 may be connected to power panel 808. One or more solar arrays 802 or stationary batteries 804 may be connected to an inverter 826, which is connected to power panel 808 and control system 810 as shown in FIG. 8. In some embodiments, inverter 826 may be configured to manage power signals received from power panel 808. Additionally, one or more electric vehicles 806 may be connected to an EVSE (Electric Vehicle Supply Equipment) charger 828. In some embodiments, EVSE charger 828 is also connected to control system 810 and power panel 808. In some implementations, EVSE charger 828 may control the rate at which electric vehicle 806 is charged or be controlled by control system 810 to limit the rate of charge to respond to increases in utility demand due to other loads (such as HVAC, other EV chargers, motor loads throughout the building, and the like).

As shown in FIG. 8, a power meter 814 is coupled to power panel 808, power grid 816, and control system 810. In some embodiments, power meter 814 monitors power usage by any number of electrical loads in a building or other area or monitors the overall load of the building as a whole. In some implementations, power meter 814 may determine how much of the power grid capacity is currently being used by connected devices or by the building. In some situations, power meter 814 may also monitor the amount of solar array 802 energy available, the amount of stationary battery 804 energy available, and the amount of energy being provided to EVs 806. Based on the determination of how much of the power grid capacity is being used and the various energy available from solar array 802 and stationary battery 804, the systems and methods described herein can determine how much remaining grid power is available for charging electric vehicles or other devices. In some embodiments, the described systems and methods may detect that a demand surge is starting to occur and then throttle back the energy being delivered to the EV chargers, thereby reducing the demand spike. In some situations, this throttling back of energy delivered to the EV chargers may significantly reduce or eliminate the costs associated with the demand surge. In particular embodiments, power may be injected from one or more stationary batteries 804 to reduce or eliminate demand spikes. The power from stationary batteries 804 may be exported to power grid 816 or may be provided to EVSE charger 828 or other system to reduce or eliminate demand spikes. Although demand surges are typically measured in 15 minute intervals, if the systems and methods respond quickly (e.g., within one or two minutes), the increased costs associated with that 15 minute demand spike may be reduced or eliminated.

Electric vehicle charging system 800 also includes a web portal 822 coupled to a data communication network 824. Web portal 822 and data communication network 824 allow the described systems and methods to communicate with other systems, servers, devices, and the like that perform a variety of operations. For example, the other systems may include smartphones, computing devices, and the like that are capable of interacting (via data communication network 824) with control system 810, electric vehicle chargers 806, and other components shown in FIG. 8. Data communication network 824 may include any type of network, such as a local area network, a wide area network, the Internet, a cellular communication network, a Bluetooth, low energy or NFC wireless connection or any combination of two or more data communication networks.

In some embodiments, data communication network 824 is coupled to weather monitoring services, weather forecasting services, power grid monitoring services, electric vehicle tracking services, electric vehicle charge monitoring services, services that monitor available vehicle charging stations in a particular area, and the like.

Data communication network 824 supports communication with other systems and methods that can provide the condition of multiple vehicle charging stations, identify the vehicle charging stations with the stationary batteries that have the highest state of charge, determine which vehicle charging stations are in the best environmental locations (e.g., vehicle charging stations that are the least shaded or in the most direct sunlight at that point in time), determine which vehicle charging stations have vacant stations for charging an electric vehicle, and the like.

In some embodiments, electric vehicle charging system 800 may determine the best use of excess power grid 816 energy at a particular time. For example, the excess power grid 816 energy may be used to charge one or more electric vehicles 806 or charge one or more stationary batteries 804. The excess power grid energy may be calculated based on how much of a building's capacity is not being used. For example, if a building has a 400 amp power grid capacity, the building may use 250 amps of that power during the day (when the building is occupied), which leaves 150 amps for charging electric vehicles 806 or stationary battery 804. At night, when the building is not occupied, the same building may use 50 amps of power, which leaves 350 amps for charging electric vehicles 806 or stationary battery 804. Similarly, the level of power consumed by the building may fluctuate frequently throughout the day as building loads such as HVAC and lighting cycle on and off. In some situations, the cost of the excess power from grid 816 may be cheaper at night than during the day.

In a particular example, a school system has a 1200 amp grid power service and 400 amps is available for new loads, such as charging electric school buses. The electric school buses may need an additional 2000 amps of grid service capability to properly charge all of the electric school buses on a typical day. Upgrading the power grid from 1200 amps to 2000 amps would be expensive and time-consuming and would require a new service drop from the electric utility, a process that can take years and entail high costs. Instead of upgrading the grid power service, the electric vehicle charging system 800 may utilize solar arrays 802 to generate energy during daytime hours to charge electric school buses and, if there is excess solar energy, store that energy in stationary battery 804. By controlling and throttling the level of charge being provided to the electric school buses in real time, the buses can be charged within the constraints of the available, unused grid power. Additionally, at night, the grid power service may have more than 400 amps available for charging the electric school buses and, if necessary, charging stationary battery 804. By using the electric vehicle charging system 800, the school system can avoid a costly and time-consuming power grid upgrade.

In this school system example, a particular implementation may install 2000 amps of solar capability from solar arrays 802 along with the 1200 amp grid power service. Excess energy from the 2000 amps solar capability may be used to charge stationary battery 804 or electric vehicle 806. This implementation may also ensure that any excess of the 2000 amps of solar energy may be used to back-feed the grid to reduce electric bill costs while utilizing the solar energy in the most optimal way. This effectively increases the local grid capacity without increasing the actual existing 1200 amp grid power service.

In some embodiments, control system 810 monitors the amount of energy received from power grid 816 and ensures that electric vehicle charging system 800 does not draw more than the available capacity limit from power grid 816. Since the available capacity limit may fluctuate throughout the day, electric vehicle charging system 800 monitors those fluctuations and adjusts the amount of energy drawn from power grid 816 based on the fluctuations. In some embodiments, a facility that includes electric vehicle charging system 800 may be monitored to detect “demand charges” and use solar array 802 energy, stationary battery 804 energy, or energy from one or more electric vehicles 806 to offset the demand charges by adding power at the moment the demand charges occur. Demand charges are fees applied to electric bills based on the highest amount of power drawn during a particular interval, such as a 15 minute interval. At peak power usage times, the demand charge fees can be significantly higher than the average fee. Thus, reducing power used from the grid during high demand charge intervals by using energy from other sources (e.g., solar array 802, stationary battery 804, or electric vehicle 806) can significantly reduce energy costs.

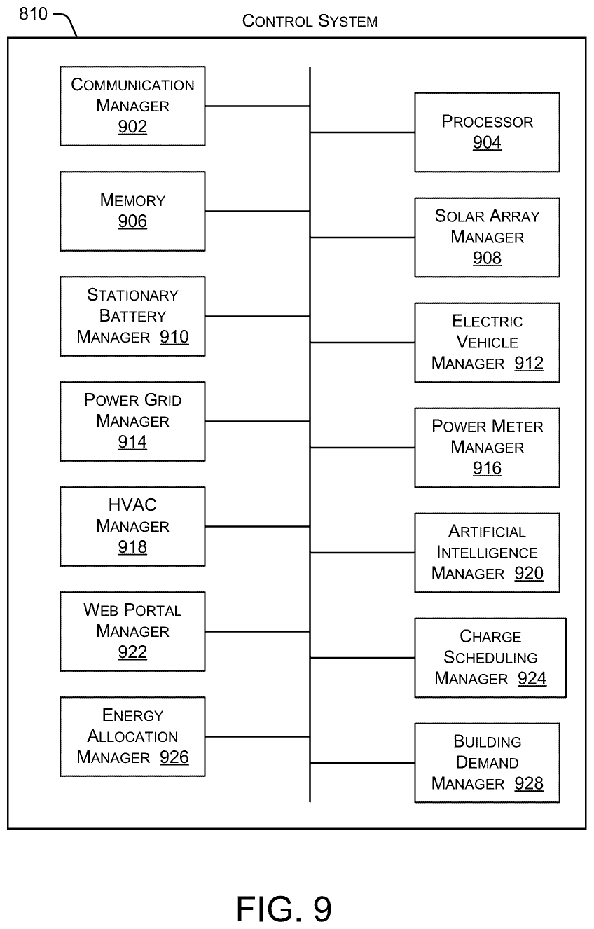

FIG. 9 is a block diagram depicting an embodiment of control system 810. As shown in FIG. 9, control system 810 may include a communication manager 902, a processor 904, and a memory 906. Communication manager 902 allows control system 810 to communicate with other systems, as discussed herein. Processor 904 executes various instructions to perform the functionality provided by control system 810, as discussed herein. Memory 906 stores these instructions as well as other data used by processor 904 and other modules and components contained in control system 810.

Additionally, control system 810 includes a solar array manager 908 that manages any number of solar arrays 802 and a stationary battery manager 910 that manages any number of stationary batteries 804. Control system 810 further includes an electric vehicle manager 912 that manages any number of electric vehicles 806, such as vehicles being charged, vehicles scheduled for charging, vehicles available for discharging (to make use of their energy), and the like. A power grid manager 914 and a power meter manager 916 may manage or determine available energy capacity associated with power grid 816.

As shown in FIG. 9, control system 810 may include an HVAC manager 918 that coordinates energy resources between EVSE chargers 828, solar arrays 802, stationary batteries 804, and power grid 816 to minimize demand spikes due to HVAC cycling. In other embodiments, the systems and methods detect demand spikes associated with HVAC cycling and reduce energy to EV chargers accordingly.

Control system 810 further includes an artificial intelligence manager 920 that that may assist with the managing and scheduling of electric vehicle charging, as discussed herein. In some embodiments, artificial intelligence manager 920 may provide the machine learning software that learns how to adapt to the changing needs of multiple variables, such as electric vehicle 806 charging needs, solar energy availability from solar arrays 802, state-of-charge level of stationary batteries 804, grid energy levels, grid energy pricing, weather trends, temperature trends, sunlight trends, historical energy usage patterns, historical electric vehicle driving patterns, and the like. Based on the multiple variables, artificial intelligence manager 920 may determine optimal charging of one or more electric vehicles 806 at, for example, lowest cost, optimal serving of loads, electric vehicle charging priority, and the like. In some embodiments, artificial intelligence manager 920 attempts to maximize use of all solar energy while minimizing the use of energy from the power grid. This approach may reduce the overall cost of operation because there is no fee for receiving solar energy, which can reduce the amount of energy from the power grid that has an associated fee.

A web portal manager 922 manages operation of web portal 822 and a charge scheduling manager 924 manages the scheduling of various electric vehicle charging sessions. Additionally, an energy allocation manager 926 manages the allocation of energy from solar array 802, stationary battery 804, electric vehicle 806, and power grid 816 to charge one or more electric vehicles or other devices. In some embodiments, energy allocation manager 926 may use energy from the battery in one electric vehicle to charge the battery in another electric vehicle. A building demand manager 928 may measure building energy demand and adjust energy usage from different sources (e.g., solar array 802, stationary battery 804, and electric vehicle 806) to reduce demand spikes associated with the cost of energy from power grid 816.

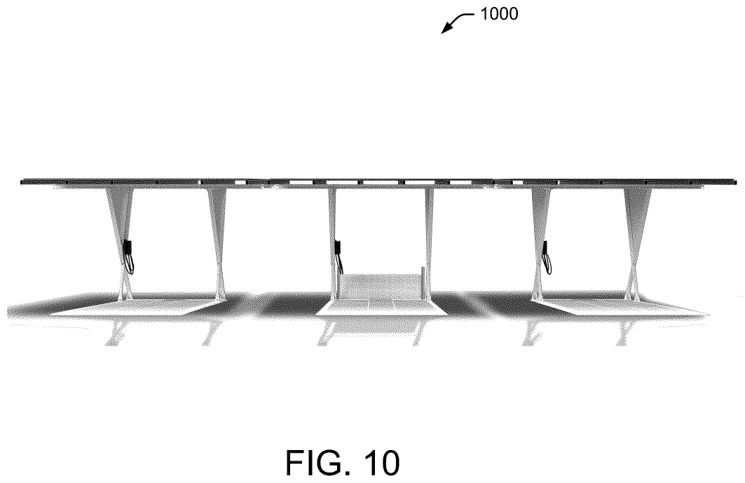

FIG. 10 depicts a front view of an embodiment of an electric vehicle charging station 1000 capable of charging multiple electric vehicles simultaneously. As shown in FIG. 10, five parking spaces are available that support the charging of five or more electric vehicles at the same time. Other embodiments may include any number of parking spaces for simultaneously charging any number of electric vehicles.

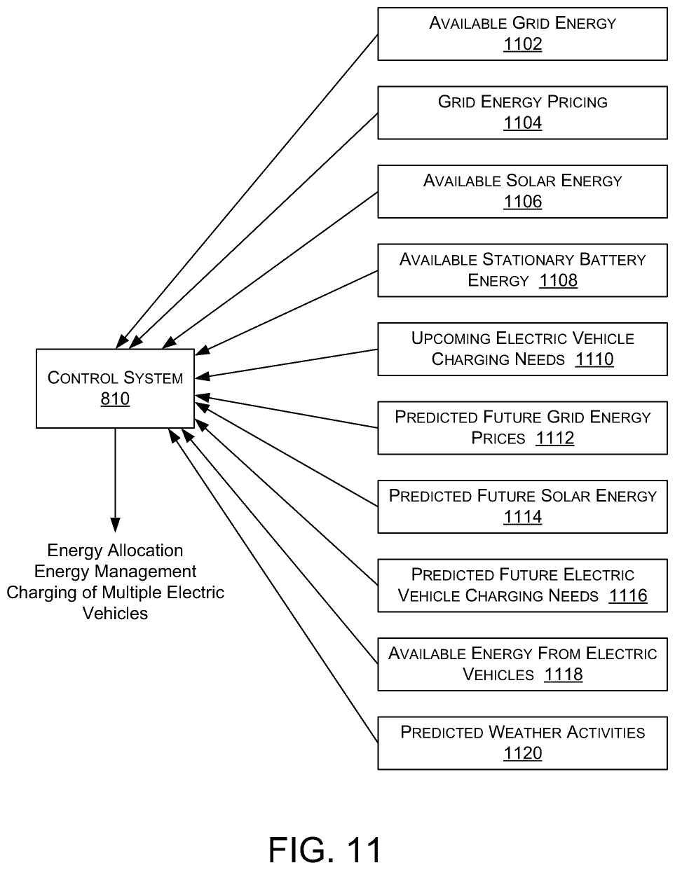

FIG. 11 illustrates an example implementation of control system 810 receiving multiple types of data from any number of data sources, data services, and the like. As shown in FIG. 11, the output from control system 810 may include one or more of energy allocation instructions, energy management instructions, or instructions to charge multiple electric vehicles, as discussed herein.

In some embodiments, control system 810 receives available grid energy data 1102 and grid energy pricing data 1104. This data about grid energy availability and pricing may be useful in determining whether to charge electric vehicle 806 using grid energy, whether to charge stationary battery 804 using grid energy, or use a different energy source. Control system 810 also receives available solar energy data 1106 and available stationary battery energy data 1108. This data about solar energy and stationary battery availability may be useful in determining whether to charge electric vehicle 806 using solar energy, whether to charge stationary battery 804 using battery energy, or use a different energy source.

Additionally, control system 810 receives upcoming electric vehicle charging needs data 1110, which may be useful in determining which electric vehicles to charge soon to meet their future needs. Control system 810 also receives predicted future grid energy price data 1112, predicted future solar energy data 1114, and predicted future electric vehicle charging needs data 1116. These three types of predicted data may be useful in allocating energy and managing charging by considering fluctuating grid energy prices, fluctuating solar energy, and the predicted charging needs of multiple electric vehicles. Control system 810 may also receive available energy 1118 from one or more electric vehicles 806. For example, in some situations it may be useful to transfer excess energy from an electric vehicle that doesn't need the excess energy to another electric vehicle that does need the energy. Control system 810 could transfer energy from a first electric vehicle to a second electric vehicle based on knowledge of the charging requirements of the first and second electric vehicles. For example, if the second electric vehicle needs a full battery charge for a long driving route the next day, energy could be transferred from the first electric vehicle that doesn't need a full charge the next day. In some embodiments, control system 810 receives predicted weather activities 1120 that may be based on historical weather patterns or current weather prediction sources. These predicted weather activities 1120 may include storms, fires, natural disasters, or other activities that may require the services of first responders. If storms, fires, or natural disasters are predicted, first responder electric vehicles 806 may be fully charged quickly to ensure they are ready for the predicted activities. Additionally, stationary batteries 804 may be fully charged so they are available to recharge electric vehicles 806 as needed.

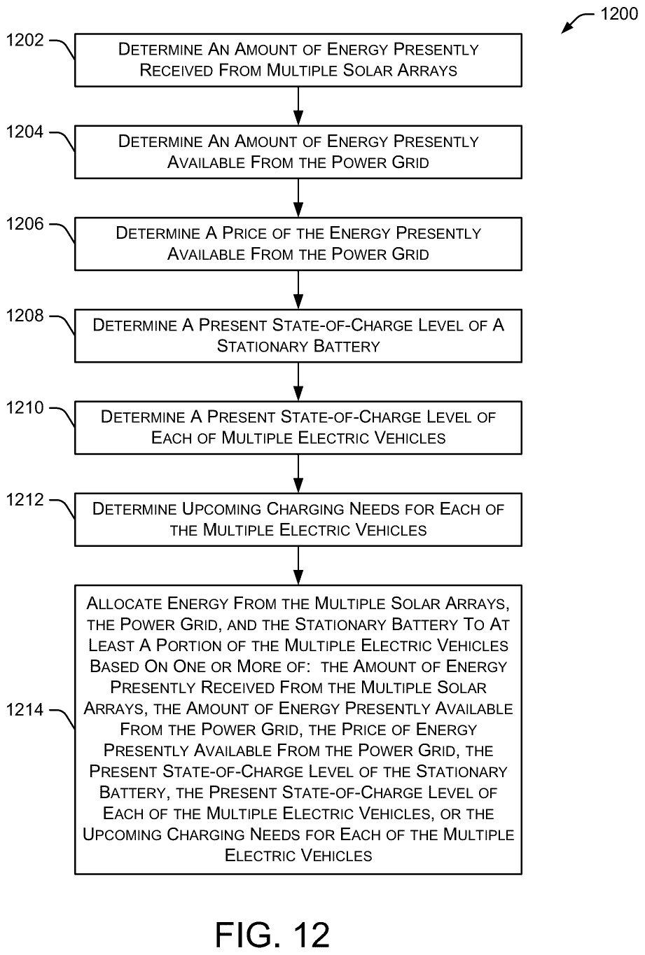

FIG. 12 illustrates an example method 1200 for managing energy resources for multiple electric vehicles. Initially, method 1200 determines 1202 an amount of energy presently received from one or more solar arrays 802. The method then determines 1204 an amount of energy presently available from power grid 816 (e.g., the available grid power before reaching the maximum grid capacity). The method continues by determining 1206 a price of the energy presently available from power grid 816.

Method 1200 further determines 1208 a present state-of-charge level of stationary battery 804. The method continues by determining 1210 a present state-of-charge level of each of multiple electric vehicles 806. The method then determines 1212 upcoming charging needs for each of multiple electric vehicles 806.

Based on the above determinations 1202-1212, the method allocates energy from the multiple solar arrays 802, the power grid 816, the stationary battery 804, and any electric vehicles 806 having excess energy available to be exported to other electric vehicles or to the power grid 816 to at least a portion of the multiple electric vehicles based on one or more of:
the amount of energy presently received from the multiple solar arrays 802
the amount of energy presently available from the power grid 816
the price of energy presently available from the power grid 816
the present state-of-charge level of the stationary battery 804
the present state-of-charge level of each of the multiple electric vehicles 806, or
the upcoming charging needs for each of the multiple electric vehicles 806.

The allocation of energy may change periodically based on changes in one or more of the determinations 1202-1212.

In some embodiments, prioritizing the charging of electric vehicles 806 may be based on a scheduled (or estimated) number of driving miles for each vehicle later in the day or during the next day. For example, if a particular electric vehicle 806 needs to drive 100 miles starting at 7:00 am the next day, then control system 810 may plan the charging of the particular electric vehicle 806 so it is ready to drive at least 100 miles by 7:00 am.

In some implementations, each electric vehicle 806 is identified based on a token, code, profile, or other identifier associated with the vehicle or the operator of the vehicle. Thus, when a particular electric vehicle 806 connects to electric vehicle charging system 800, the system knows the electric vehicle type, charging history, charging priority, and the like. Based on the identification of the particular electric vehicle 806, electric vehicle charging system 800 may assign a charging priority and charging rate based on other vehicles currently being charged and other vehicles that need charging in the near future. For example, a police station or fire station may have one or more electric vehicles connected to electric vehicle charging system 800 that need to be charged first or charged to a higher level. Those electric vehicles are given priority over other electric vehicles awaiting charging. Other electric vehicles may be given priority based on the amount paid by the owner of the electric vehicle, a subscription plan associated with charging the vehicle, and the like. Some electric vehicles may have a predetermined profile that defines the charging preferences or charging priorities for the specific electric vehicle. The electric vehicle charging system 800 may then charge the electric vehicle based on the associated profile.

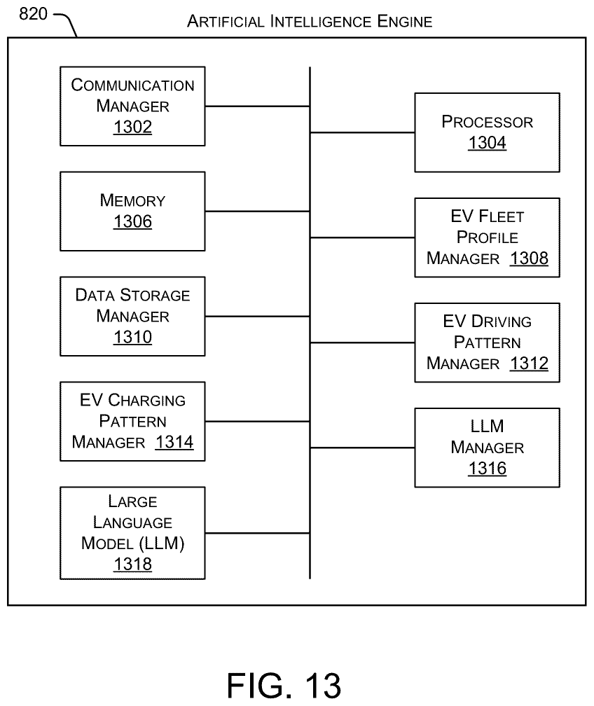

FIG. 13 is a block diagram depicting an embodiment of artificial intelligence engine 820. In some implementations, one or more components of artificial intelligence engine 820 may support (or perform) functions or operations discussed herein with respect to control system 810. Artificial intelligence engine 820 may assist with the management and scheduling of electric vehicle 806 charging, stationary battery 804 charging as discussed herein.

As shown in FIG. 13, artificial intelligence engine 820 may include a communication manager 1302, a processor 1304, and a memory 1306. Communication manager 1302 allows artificial intelligence engine 820 to communicate with other systems. Processor 1304 executes various instructions to perform the functionality provided by artificial intelligence engine 820, as discussed herein. Memory 1306 stores these instructions as well as other data used by processor 1304 and other modules and components contained in artificial intelligence engine 820.

Additionally, artificial intelligence engine 820 includes an EV fleet profile manager 1308 that can manage multiple electric vehicles in a fleet of vehicles. EV fleet profile manager 1308 can manage, for example, vehicle charging priorities, average miles driven by each vehicle, expected miles that will be driven in the near future, and the like. A data storage manager 1310 manages various stored data, such as historical data, vehicle data, driving route data, and the like.

An EV driving pattern manager 1312 monitors and tracks driving patterns associated with any number of electric vehicles. These driving patterns may include information related to distances driven, routes driven, average number of miles driven per day, what time of day is the vehicle typically driven, and the like. Artificial intelligence engine 820 also includes an EV charging pattern manager 1314 that monitors and tracks patterns associated with charging any number of electric vehicles. An LLM (Large Language Model) manager 1316 manages one or more LLMs used by artificial intelligence engine 820. For example, LLM manager 1316 may manage training the LLM, updating the LLM, and the like. Artificial intelligence engine 820 further includes LLM 1318 that includes any number of models associated with the charging of electric vehicles 806, stationary battery 804, distribution of energy, scheduling of electric vehicle charging, and the like.

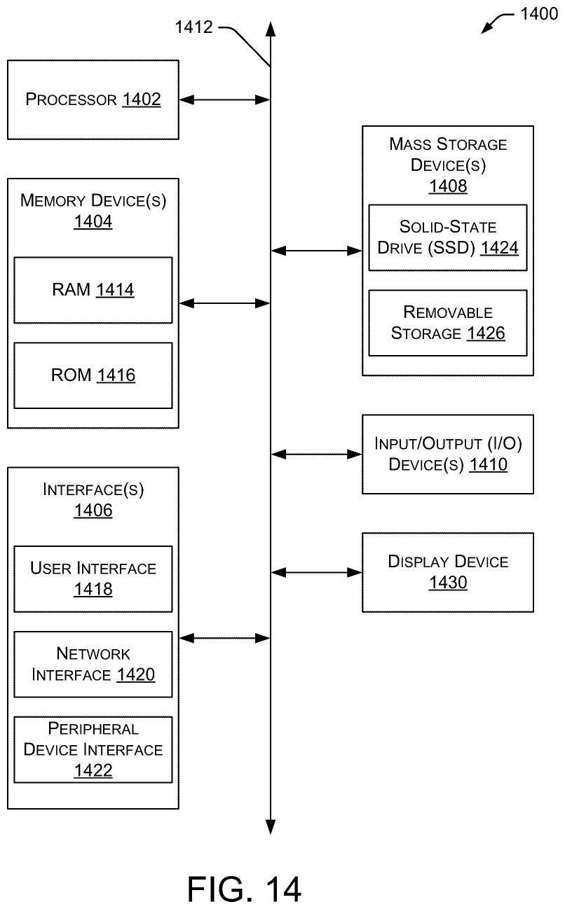

FIG. 14 depicts a block diagram of an embodiment of a computing device 1400. Computing device 1400 may be used to perform various procedures, such as those discussed herein. Computing device 1400 can execute one or more application programs, such as the application programs or functionality described herein. Computing device 1400 can be any of a wide variety of computing devices, such as an embedded processor, desktop computer, a notebook computer, a server computer, a handheld computer, tablet computer, smartphone, a wearable device, and the like.

Computing device 1400 includes one or more processor(s) 1402, one or more memory device(s) 1404, one or more interface(s) 1406, one or more mass storage device(s) 1408, one or more Input/Output (I/O) device(s) 1410, and a display device 1430 all of which are coupled to a bus 1412. Processor(s) 1402 include one or more processors or controllers that execute instructions stored in memory device(s) 1404 and/or mass storage device(s) 1408. Processor(s) 1402 may also include various types of computer-readable media, such as cache memory.

Memory device(s) 1404 include various computer-readable media, such as volatile memory (e.g., random access memory (RAM) 1414) and/or nonvolatile memory (e.g., read-only memory (ROM) 1416). Memory device(s) 1404 may also include rewritable ROM, such as Flash memory.

Mass storage device(s) 1408 include various computer readable media, such as magnetic tapes, magnetic disks, optical disks, solid-state memory (e.g., Flash memory), solid-state drives (SSDs), and so forth. As shown in FIG. 14, a particular mass storage device is a solid-state drive 1424. Various drives may also be included in mass storage device(s) 1408 to enable reading from and/or writing to the various computer readable media. Mass storage device(s) 1408 may include removable media 1426 and/or non-removable media.

I/O device(s) 1410 include various devices that allow data and/or other information to be input to or retrieved from computing device 1400. Example I/O device(s) 1410 include smartphones, RFID readers, cursor control devices, keyboards, keypads, microphones, monitors or other display devices, speakers, printers, network interface cards, modems, and the like.

Display device 1430 includes any type of device capable of displaying information to one or more users of computing device 1400. Examples of display device 1430 include a smartphone, display screen, an external PC, a monitor, display terminal, video projection device, and the like.

Interface(s) 1406 include various interfaces that allow computing device 1400 to interact with other systems, devices, or computing environments. Example interface(s) 1406 may include any number of different network interfaces 1420, such as interfaces to local area networks (LANs), wide area networks (WANs), wireless networks, cellular modem networks, and the Internet. Interface(s) 1406 may further include an external smartphone (or other portable computing device) that uses a browser as an interface to cloud-based computing systems and the like. Other interface(s) include user interface 1418 and peripheral device interface 1422. The interface(s) 1406 may also include one or more user interface elements 1418. The interface(s) 1406 may also include one or more peripheral interfaces such as interfaces for printers, pointing devices (mice, track pad, keypad, or any suitable user interface now known to those of ordinary skill in the field, or later discovered), keyboards, and the like.

Bus 1412 allows processor(s) 1402, memory device(s) 1404, interface(s) 1406, mass storage device(s) 1408, and I/O device(s) 1410 to communicate with one another, as well as other devices or components coupled to bus 1412. Bus 1412 represents one or more of several types of bus structures, such as a system bus, PCI bus, IEEE bus, USB bus, CAN bus, powerline communications (PLC) bus, and so forth.

For purposes of illustration, programs and other executable program components are shown herein as discrete blocks, although it is understood that such programs and components may reside at various times in different storage components of computing device 1400, and are executed by processor(s) 1402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
determining, by a control system, an amount of energy presently available from an existing power grid connection;
determining, by the control system, an amount of energy presently received from a solar array;
identifying, by the control system, a present state-of-charge level of a stationary battery; and
allocating, by the control system, energy to charge a first plurality of electric vehicles, wherein energy is allocated from at least one of the existing power grid connection, the solar array, or the stationary battery based on:
the amount of energy presently available from the existing power grid connection;
the amount of energy presently received from the solar array; and
the present state-of-charge level of the stationary battery.

2. The method of claim 1, wherein energy is further allocated from at least one of the existing power grid connection, the solar array, or the stationary battery based on an amount of charge an electric vehicle is requesting or offering.

3. The method of claim 1, wherein allocating energy is further based on at least one of:
a price of energy presently available from the existing power grid connection;
an estimated price of energy from the existing power grid connection in the near future; or;
energy currently being consumed by an electric service to which the control system is coupled.

4. The method of claim 1, wherein allocating energy is further based on:
current energy needs to charge the first plurality of electric vehicles; and
future energy needs to charge a second plurality of electric vehicles.

5. The method of claim 1, wherein allocating energy is further based on at least one of:
a present state-of-charge level of each of the first plurality of electric vehicles;
a present state-of-charge level of each of the second plurality of electric vehicles;
a charging priority associated with at least a portion of the first plurality of electric vehicles; or
forecast energy expected to be received from the solar array in the future.

6. The method of claim 1, wherein allocating energy is further based on a price of energy from the existing power grid connection at a future time.

7. The method of claim 1, wherein allocating energy to charge a first plurality of electric vehicles is further performed by an artificial intelligence engine.

8. The method of claim 1, wherein allocating energy to charge a first plurality of electric vehicles is further based on data from a Large Language Model (LLM).

9. The method of claim 1, further comprising identifying at least one of the first plurality of electric vehicles that is requesting charging.

10. The method of claim 9, further comprising:
determining charging data associated with the identified electric vehicle; and
charging the identified electric vehicle based on the charging data associated with the identified electric vehicle, wherein the charging data associated with the identified electric vehicle includes at least one of a vehicle priority, a vehicle charging rate, or a vehicle charging method.

11. An apparatus comprising:
a solar array configured to generate energy in response to received sunlight;
a stationary battery configured to store energy; and
a control system configured to:
determine an amount of energy presently available from an existing power grid connection;
determine an amount of energy presently received from the solar array;
identify a present state-of-charge level of the stationary battery; and
allocate energy to charge a first plurality of electric vehicles, wherein the energy is allocated from at least one of the solar array, the existing power grid connection, or the stationary battery based on:
the amount of energy presently available from the existing power grid connection;
the amount of energy presently received from the solar array; and
the present state-of-charge level of the stationary battery.

12. The apparatus of claim 11, wherein energy is further allocated from at least one of the solar array, the existing power grid connection, or the stationary battery based on an amount of charge an electric vehicle is requesting or offering.

13. The apparatus of claim 11, wherein the control system is further configured to allocate energy based on at least one of:
a price of energy presently available from the existing power grid connection;
an estimated price of energy from the existing power grid connection in the near future; or
energy currently being consumed by an electric service to which the control system is coupled.

14. The apparatus of claim 11, wherein the control system is further configured to allocate energy based on:
current energy needs to charge the first plurality of electric vehicles; and
future energy needs to charge a second plurality of electric vehicles.

15. The apparatus of claim 11, wherein the control system is further configured to allocate energy based on at least one of:
a present state-of-charge level of each of the first plurality of electric vehicles;
a present state-of-charge level of each of the second plurality of electric vehicles;
a charging priority associated with at least a portion of the first plurality of electric vehicles; or
forecast energy expected to be received from the solar array in the future.

16. The apparatus of claim 11, further comprising an artificial intelligence engine coupled to the control system and configured to manage charging of the first plurality of electric vehicles.

17. The apparatus of claim 16, wherein the artificial intelligence engine is further configured to prioritize and schedule charging activities associated with the first plurality of electric vehicles.

18. The apparatus of claim 11, wherein the control system is further configured to allocate energy to charge the first plurality of electric vehicles based on data from a Large Language Model (LLM).

19. The apparatus of claim 11, wherein the control system is further configured to identify at least one of the first plurality of electric vehicles that is requesting charging.

20. The apparatus of claim 19, wherein the control system is further configured to:
determine charging data associated with the identified electric vehicle; and
charge the identified electric vehicle based on the charging data associated with the identified electric vehicle, wherein the charging data associated with the identified electric vehicle includes at least one of a vehicle priority, a vehicle charging rate, or a vehicle charging method.
